(19) United States
(12) Patent Application Publication
(10) Pub. No.: US 2003/0236730 A1
(43) Pub. Date: Dec. 25, 2003

(54) Method for promoting, organising an managing communications and exchanges on a communication network

(76) Inventor: Jean-Claude Vich, Asnieres (FR)

Correspondence Address: William A. Drucker, 1901 L Street, N. W., suite 800, Washington, DC, 20036-3506, US

(21) Appl. No.: 10/219,293

(22) Filed: Aug. 16, 2002

(30) Foreign Application Priority Data
Jun. 19, 2002 (FR) 02 07590

(51) Int. Cl. G06F 17/60

(52) U.S. Cl. 705/36; 705/37

(57) ABSTRACT

The method of the invention includes the selection of target entities according to criteria determined by a canvassing entity and/or by a server center so as to set up an overall target file for this canvassing entity, the supplying to the entities of the target file of means for access to a general information presentation site and the presentation to each of the target entities seeking access to the general information presentation site of information specific to the canvassing entity for which it has been selected.

### BACKGROUND OF THE INVENTION

1. Field of the Invention

The present invention concerns a method for promoting, organising and managing communications and exchanges on a communication network, such as the Internet network, between at least two populations, namely a population of canvassing entities, each of said entities seeking to enter into communication with target entities satisfying criteria defined by the canvassing entity, and a target population including the target entities of the canvassing entities.

It can be applied in particular, but not exclusively, to the putting into relation suppliers offering products and/or services and potential buyers likely to use these products and/or services.

For this type of application, the object of the invention is to enable concerns offering products and/or services to specifically target a population (target) able to constitute potential customers, organise communication with its potential customers and develop customer loyalty by setting up permanent relations with said customers.

2. Description of the Prior Art

Generally, it is known that electronic trade is starting to develop and that concerns are increasingly tending to open Internet sites including virtual galleries for displaying their products and/or services.

Thus, these sites constitute genuine show windows accessible to all users of Internet. Therefore, it is reasonable to think that the opening and maintaining a site are in themselves sufficient to be able to benefit from all the potential advantages of the network.

In fact, it is shown that these advantages are reduced owing to a number of limitations due to the considerable volume of information available on internet and the number of internet users navigating on this network, most of the time anonymously.

Thus, the frequency of access to a site depends mainly on its being referenced on the search engines and the reputation of the name of the area concerned, it being understood that nevertheless there is a significant number of random accesses due to the erratic navigations of Internet users.

Now, the referencing of a field name is becoming more and more of a problem, especially at the international level. The renown of the name is acquired much more by advertising campaigns carried out on conventional media sources, such as the Internet network which proves to be less adapted to selective advertising, especially in fields where the parties concerned rarely navigate.

Furthermore, the statistical data relating to accesses to the site are difficult to exploit owing to the anonymity of these Internet users. The solutions put forward to break this anonymity and obtain information on these Internet users accessing the site come up against the following dilemma:

access to the contents of the site require that the Internet user previously completes an information card: this formula has the drawback of being less attractive, and in fact maybe be a deterrent.

access to the contents of the site is free: the internet user can visit the site without agreeing to complete an optional card provided for this purpose. It is clear that this formula is more attractive, but does not resolve the problem of identifying the Internet user visiting the site.

### OBJECT OF THE INVENTION OBJECT OF THE INVENTION

Thus, the object of the invention is in particular to eliminate the previously mentioned drawbacks and resolve this dilemma.

### SUMMARY OF THE INVENTION

To this effect, the method of the invention introduces a server centre connected to the Internet network and carries out the following operations for each of the canvassing entities:

the selection of the target entities according to criteria determined by the canvassing unit and/or by the server centre so as to set up a global file for this canvassing unit,

the supplying to the entities of the target file means for access to a general information presentation site whose contents are independent of the activity of the canvassing entity and are of a nature to attract said potential buyers, this general information presentation site being at least partly exclusively reserved for those entities featured in the target files of all the canvassing entities taken in charge by the server centre, and

the presentation to each of the target entities seeking accessing the general information presentation site information specific to the canvasser for which it has been selected.

Advantageously, the server could provide any entity which so desires with the general presentation information from all the potential buyer entities, as well as possibly a synthetic presentation of the general information shown on the site so as to attract new canvassing entities and new entities likely to become targets for canvassing entities.

The means of access by the entities of the target file to the general information presentation site can consist of an access code which is offered to each of the target entities and is financed by a canvassing entity.

In these conditions, when an entity of a target file having an access code wishes to access the general information presentation site of the server centre, it moves though a tunnel page containing general information on at least the canvassing entity which has provided it with the access code and control means for access to the general information presentation site. Thus, each time a target entity consults the general contents of the site, it takes cognizance of the possibly customised offer of the canvassing entity which has provided it with the access code.

Each tunnel page with access to the data base may further include access to information specific to a concern having provided the access code.

Thus, for example, each tunnel page with access to the base could contain an access to an Internet site of the concern having given an access code to a user concern and an access for a written request for additional information concerning the products or services of the entity having provided the access code. A call button could also be provided on the tunnel page to permit telephone communication between the target entity and the entity which has provided the access code.

By means of these arrangements, the method of the invention makes it possible to:

target potential customers (potential buyers) more specifically,

forward the potential buyers to a potential buyer concern (offer and sales presentation

canvassing at local, national and international levels, especially by means of the attractive nature of the general information presented and which shall be continuously renewed.

### BRIEF DESCRIPTION OF THE DRAWINGS

There follows hereafter a non-restrictive example of an embodiment of the invention with reference to the accompanying drawings on which:

FIG. 1 is a diagrammatic representation showing the various entities implemented by the method of the invention, said entities being connected to the Internet network and possibly to the telephone network RTC.

FIG. 2 is a mimic diagram illustrating the general principle of the method of the invention.

FIG. 3 is a diagrammatic representation illustrating the various stages offered to an anonymous visitor.

FIG. 4 is a representation similar to that of FIG. 3 for an input on the site of a visitor already inscribed provided with a login.

FIG. 5 is a diagrammatic representation illustrating the stages allowing access to free access articles.

### DESCRIPTION OF THE PREFERRED EMBODIMENTS

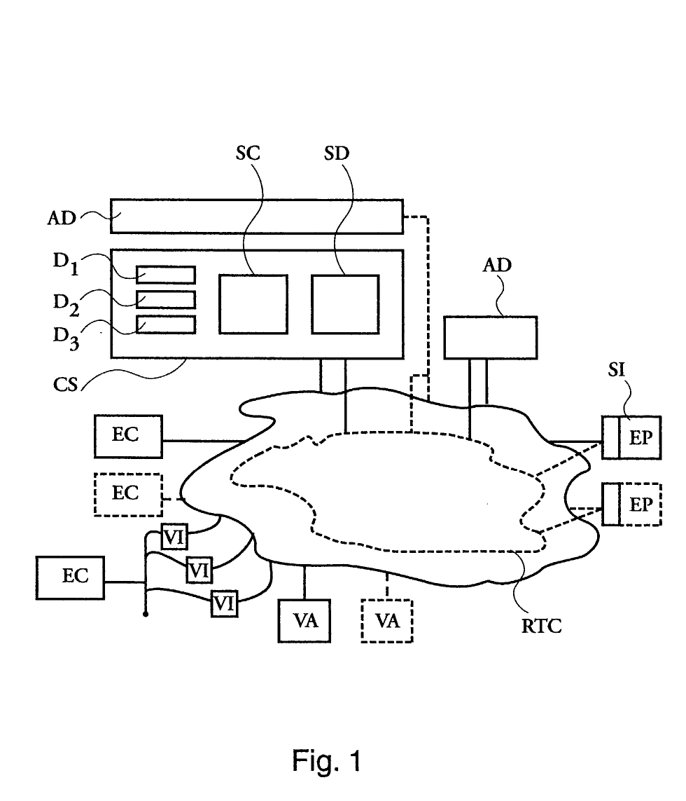

In this example, the method of the invention makes use of a communication network, such as an Internet network to which, as shown on FIG. 1, the following are connected:

a population of canvassing entities EP, generally small or average-sized concerns which would like to take part in large scale potential buying operations (when operations of this type are normally reserved for large concerns having available sufficient budgets, human resources and the internal skills for carrying out or having carried out significant activities). These canvassing entities EP may have an Internet site SI comprising a virtual gallery for presenting the products and/or services they wish to sell. These entities EP must immediately define the profile of the targets they seek to reach, especially via criteria, such as geographical zone, activity, manpower of the concern, etc.

a population of target entities EC, for example concerns able to possibly have available an Intranet network. This population could initially be selected by conventional methods by means of selection criteria determined by the canvassing entities. It could then be self-maintained and even develop by virtue of the self-enrichment characteristics of the method of the invention. In principle, these target entities or potential buyers are likely to be interested by the products and/or services of at last one canvassing entity, it being understood that a given entity could constitute the target of several canvassing entities. A target entity could include several visitors VI interested by an access to the site.

a population of anonymous visitors VA able to subsequently become target entities or subscribers.

a server centre CS managed by an administrator and having around a processor at least one data base D₁ relating to the target entities, a data base D₂ relating to the canvassing entities, a data base D₃ relating to visitors (identification, particular characteristics, activity, . . . ), a commercial site SC for selling services to concerns and for creating relational inter-concern traffic and a site SD comprising editorial contents with access controlled by login (ACL) and password with payment of the article as requested.

Of course, these sites SC, SD need to be accessible via the Internet network and be quickly, simply and reliably remote-administered by an administrator offering total security.

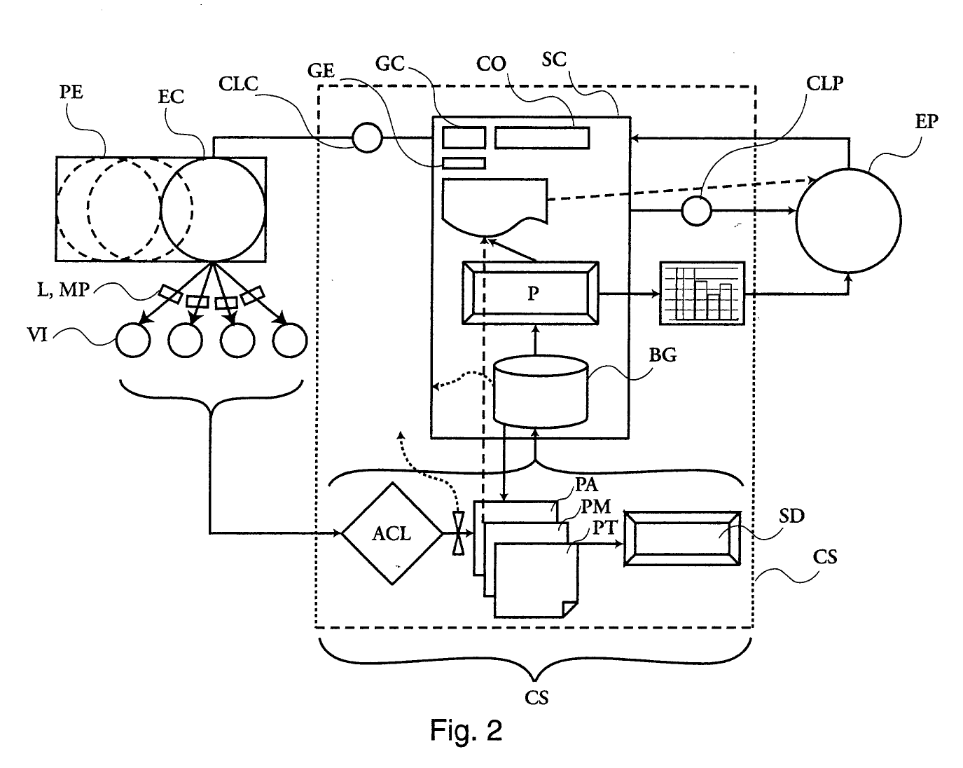

The services commercial sales site SC creates for each canvassing entity EP a park of target entities EC (all those concerns targeted for this canvasser). It allocates to each target entity EC a key CLC and to the canvassing entity a canvassing key CLP. The key CLC, reserved for a target concern EC as part of an operation, could be used by one or several visitors VI so as to be registered. It allows a newly registered visitor to benefit from a points account credit valid throughout the period of the operation with a date of validity able to be carried forward. This key CLC can be used to create a parameterable number of login password pairings L, MP. Allocated to each operation is an operation code CO provided for a maximum number of keys CLC. Each key CLC is active when it is associated with one or several login/password pairings L, MP selected by visitors VI (FIG. 2).

Advantageously, the commercial site SC shall include means GC for automatically generating keys CLC and means GE for associating these keys:

with the identifications of the target entities of the operation in question,

with the maximum number of login/password pairings L, MP authorised for each key CLC, this number being equal to the workforce of the target concern EC to which the key CLC relates

a key CLC could be:

inactive (no visitor has used it to create his login)

active (a visitor has created his login by using this key)

blocked level 1 as per a decision of the administrator (impossible to create new login/password pairings and the existing logins remain operational)

blocked level 2 as per a decision of the administrator (impossible to create new login/passwords and the existing logins are also blocked)

expired if the date of validity has expired.

a CLC or CLP key could be associated with:

a creation date

a date of sending to the target entity

a sending support to the target entity

a maximum number of authorised logins (corresponding to a list of associated logins)

a validity limit date

a type of key

an operation code

a status

All the keys CLC or CLP are stored in a data base and refer to the information of the corresponding operation (canvassing entity, target entity, dates).

The administrator AD must be able to:

generate additional keys for a given operation,

select a set of keys and modify once their validity limit dates,

be advised of the advance of keys arriving on the validity limit per type of key.

The period of validity express the period during which the addressee entity could use this key CLC to on-line access the general information presentation site comprising the editorial contents SD. Beyond this period, the key CLC is no longer valid.

The keys CLC are valid throughout the period of the operation and for a predetermined period, such as six months beyond the end of the operation.

The administrator needs to be able to select the keys CLC with an operation code CO and globally modify their dates of validity.

The administrator AD needs to be able to edit a condition of all the password/login pairings L, MP originating from a given key CLC, this state mentioning the number of keys and a list indicating for each key CLC:

the corresponding target concern

the country, town, department and address of the concern

the activity of the concern

the manpower of the concern

the status of the key (active, inactive).

Means could be provided to carry out crossed selections and groupings via:

Operation code CO

Key CLC

Key status

Country

Town

Department

on a given date

The administrator AD could further edit a state whose maximum number of login/password pairings L, MP has been reached with the dates of the first and final login created.

The creation of password/login pairings L, MP is effected as follows:

The visitor, with or without a key CLC, who wishes to be registered on the general information presentation site SD on line completes an identification form, enters his possible key CLC and creates his login L and password MP. The login L requested from the visitor preferably corresponds to his telephone number. The password MP is freely selected by the visitor. The data base then ensures the relation between the login/password pairing L, MP and the original key CLC.

Any login L corresponds to a visitor identification form with certain obligatory fields, including for example:

a password

a creation date

a date of validity

a paying or offered indication

a status (active, blocked, cancelled)

status change dates

a points account

a login type

possibly a key.

The identification information of a visitor who changes type of login need to be retained, the administrator Ad needing to be advised by editing a report listing the identification modifications, said statement mentioning the information before and after modifications. Similarly, the administrator could select the logins on the basis of various crossed criteria:

by login characteristics

by operation codes

by the number of associated operation codes

by status of the associated operation codes

by visitor data: address, company activity, purpose, workforce.

The logins offered already created remain active, even after the original key has expired. Any login can at any time be associated with one or several operation codes.

It must be possible:

to select an existing set of logins L and associate them with a catalogue code so as to create a catalogue of target entities,

to move a previously existing paying login in to an offered logic type in which the visitor receives a key a posteriori.

The administrator AD checks a posteriori the serious nature of the information mentioned in the identification form. If the information is not considered reliable, the login L shall be suspended, indeed blocked indefinitely. If the points account of the visitor becomes exhausted, the login becomes inoperative.

In fact, it shall be possible to provide four types of logins, namely:

the administrator login AD allowing access to the global indicators of the site and to all the articles without any limit of validity and points account.

the visitor login: this is a login provided for visitors not having subscribed to a conventional formula (paying login)

the subscription login: this is the login of a visitor having taken out a subscription to the general information presentation site SD

the offered login: this is a login originating from a key. This login is valid as long as the operation takes place and for six months after the end of the operation (date able to carried forward).

The states concerning the logins L could include for each of the logins L the name, forename, email, personal address, telephone number, profession, company, country, town, Department of the company address, company activity, workforce of the company, date of registration, operation code, etc.

A crossed section could be made on:

the login status

a given date

the date of registration

an interval between two dates

the operation code

the country

with possible cascade pooling concerning:

the operation code

the concern

the country

the Department

Of course, it ought to be possible to edit a statement of all the exhausted points accounts with the expiry dates with extraction of the associated identification information and emails. This data shall be exported to an “e-mailing” electronic application.

Registration to the site comprising editing contents SD can be effected according to two methods (with or without key), the visitor needing in all cases to be identified in a formula and being able to possibly participate in a game decided by a random draw for winning a prize each month.

So as to be registered, the visitor provided with a key CLC shall enter his key and fill out a registration form by supplying information and identification data. If the key CLC is valid, it gives the visitor the right to a preparametered points credit.

In a case where the visitor has no key CLC, he needs to be registered by filling out a registration form of the type previously mentioned above but in addition comprising data relating to the payment of a subscription, for example via automatic deduction from his bank account or by blue card. The visitor could choose from several offered subscription formulae.

The list of the registrations accompanied by the main information of the registration forms could be edited with selection criteria, such as:

period during which registration is made

registration with or without a key

logins

The contents of the general information presentation site SD could appear in two parts, namely:

a first part containing articles accessible to all the logins, for example in the news, selection, library, dictionary headings,

a second part containing articles solely accessible to paying logins, for example in a selection heading.

Each article represents a number of points and includes details of the advantages of the article on sale accessible to all the visitors and contents subject to payment via a points account (which needs to be sufficiently in credit having regard to the number of points required for the article). The debit of the point account can be fully seen by the visitor and is made instantaneously. Only if the points account is not sufficiently in credit that a particular message is displayed to advise the visitor.

Any visitors registered on the service sales commercial site SC can buy a point reload to credit his points account.

In this case, an offered login becomes a paying login and its rights and rights of access are extended to the whole of the site.

Having regard to the preceding in a points account of a visitor, two point reserves can be found:

a reserve for the site SC which is not able to be brought forward from one month to another. Its date of validity is not modified by the points reloads.

a paying reserve which accommodates all the points bought by the customer concerning the various formulas offered. The balance of this reserve is brought forward from one month to another. The date of validity is brought forward according to the reloads bought by the visitor.

As regards the login period of validity, this period corresponds to the start period of the original key. However, so as to keep his active login, the visitor needs to visualise during the quarter at least once each existing tunnel page at the start of the quarter (or at the end of the quarter).

If the visitor has not seen the required number of tunnel pages within a specific number of days (such as 10) before the end of the quarter, he receives (for example by email) a warning message.

Of course, the visitor is able at any time to consult the balance of his points account.

All the data relating to reload purchases, regardless of the formulae, are exported to an invoicing management system.

The service sales commercial site SC offers two types of services:

catalogue operations with a choice from existing target entities EC, each target entity EC corresponding to a certain number of existing qualified logins;

tailor-made operations using the selection criteria of the target entities.

Of course, the applicant needs to provide a certain minimum amount of information so that the commercial site SC can examine his operation (NAF codes, Departments, workforces of those concerns to be targeted, number of concerns to be targeted).

A concern which has subscribed to one or several operations is a canvasser (or canvassing entity).

If a potential buyer has no current operation, he becomes a “former potential buyer”.

A given concern may be: potential buyer and target, canvasser and target or former canvasser and target.

An operation is characterised by:

the identity of the canvassing entity (concern or natural person)

a subscription date

target selection criteria

a park of targets (a posteriori)

a date scheduled for start of the operation

a real start date

an end of operation date (a posteriori)

a spokesperson for management of the operation

an operation code for identifying all this data

dates and sending supports of keys to the targets of the operation

a list of corresponding keys

As it takes place, the operation then corresponds to a list of logins with their identification data.

The administrator AD needs to be able:

to select and edit/export all the logins L associated with an operation code

select all the operation codes of a given canvassing entity EP

Of course, the commercial site SC shall make use of a purchaser identification formula possibly including for example:

a choice of the service with the corresponding price (form with boxes to tick and pull-down lists) completed on-line by the buyer, this form being sent and stored in a data base so as to be processed by the administrator,

a choice of options for executing the service (pull-down lists), protected payment parameters,

a validation, for example by an electronic signature and authentication system.

All this data shall be accessible by the administrator.

On the basis of the criteria selected by the canvasser, the commercial site SC shall make the necessary extractions from his data bases and shall set up the overall target file of the canvasser, it being understood that the site SC manages the data base, the target files and the use of addresses of concerns in the various subscribed operations.

At the end of an operation concerning it, a target concern becomes a former target concern for this operation.

A concern can simultaneously be:

a target of operation A

a target of operation C

a former target of operation B

etc.

As previously mentioned, any visitor wishing access to the general information presentation site SD needs to successively move through a welcome page PA, a mosaic page PM, a tunnel page PT and a summary of the information displayed on the site.

The welcome page could show a summary list of the articles of the site SD associated with a number of points. The articles worth a zero point being accessible to any visitor (with or without having entered a login).

The mosaic page PM may comprise four to sixteen text illustrations, some of these comprising a hanger content towards a tunnel page PT and others may be decorative.

The visible text illustrations are those which correspond to the parametered operation codes for the login L.

View text illustrations (that is clicked to access corresponding the tunnel page PT) during a predetermined period, for example a quarter, shall appear in a different colour so that the visitor immediately knows which he needs to look up.

As regards those visitors having a login, any entry in the site SD passes once via the mosaic page PM which shows the text illustrations summarising the tunnel pages PT parametered for the login used. Next, the visitor continues his visit without having to go back through a mosaic page PM and a tunnel page PT. If the login is associated with more than four or sixteen operation codes and thus with more than four or sixteen tunnel pages, several mosaic pages shall be available and be displayed in rotation during each session.

Anonymous visitors VA can enter the site without providing a login. However, this absence of login is managed as a virtual login: these visitors VA also see mosaic or tunnel pages displayed just like visitors having entered a login.

However, anonymous visitors must pass through the mosaic+tunnel pages before each article is displayed.

During his visit, the visitor can at any time consult the set of mosaic PM and tunnel PT pages associated with his login L.

From any tunnel page PT, the visitor can access an information request form FD concerning the offer shown on the tunnel page PT.

These forms are stored in a data base of the site SC and need to be able to be quickly and simply re-routed towards the canvassing entities.

The previously mentioned various modes of operation are shown in detail hereafter with regard to FIGS. 2 to 5.

Thus, as shown on FIG. 2, the canvassing entity EP which wishes to launch a canvassing operation applies to the commercial site SC which creates an operation code (CO) and then generates a key CLC (automatic key generator GC) associated with the identifiers of the target entities EC of the operation concerned. By means of this key, the target entity EC shall be able to draw up login/password pairings for visitors VI (managers/collaborators) who could access the contents of the site SD. This access is obtained by means of the login/password pairing able to be verified by the server centre CS. Depending on the login, the commercial site SC determines by means of its processor P and general data base BG the mosaic page and the tunnel page corresponding to the canvassing entity EP which has launched the operation. Access to the site SD can be obtained from the tunnel page PT. The general data base then records the data relating to the characteristics of the visitor (identification, concern, operation). The site SC draws up a table of efficiency measurement indicators and sends it to the canvassing entity EP.

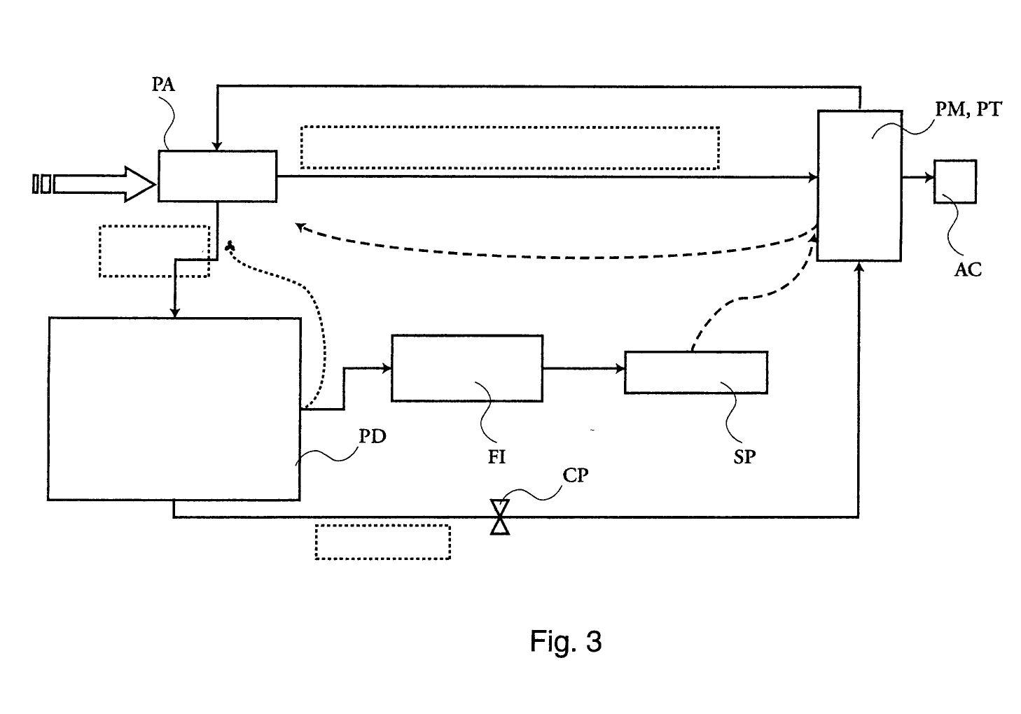

Entries of anonymous visitors on the site SD is effected in accordance with the diagrammatic representation of FIG. 3 by means of a summary page giving all the headings of the articles with the number of points associated with them, it being understood that only those articles worth a zero point are accessible to anonymous visitors not having a login. A click of an article with a zero point provokes the displaying of a mosaic page and a tunnel page prior to access to the selected article AC. If the anonymous visitor does not validate the zero point page he has selected, he returns automatically to the summary page PA.

If the article selected in the page PA is accessible solely to those visitors registered on the site SD, the visitor shall be invited (didactic page PD) to enter his login/password pair and click on a heading called “registration”. He shall then obtain the displaying of a registration form F1 with subscription and payment SP. Then a login/password pair shall be created and then switched on the mosaic and tunnel pages.

Of course, once the visitor has a login/server pair recognised by the site, he can directly access the mosaic and tunnel pages after entering and validity control CP of the login/password pair.

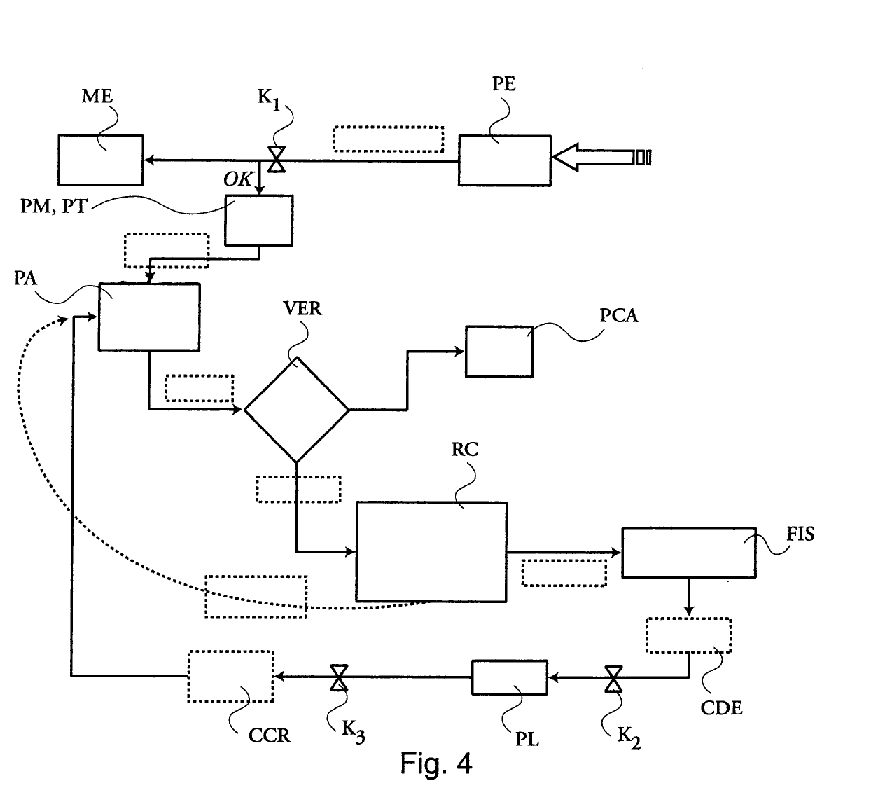

Entering with login in the site SD is carried out in accordance with the diagram of FIG. 4 by entering the welcome page PE, by entering the login/password pair so as to be able to enter if the control is positive (control K₁) in the mosaic PM and tunnel PT pages. If the control is negative, an error message ME is displayed and a link to the registration stages is established.

If the control K₁ is positive, the mosaic page PM corresponding to the entered login is displayed with a possibility of access to the corresponding tunnel page PT. The visitor can then move to the summary page PA of the site SD and then select and validate an article on the summary page PA. The account of the visitor is then verified (block VER) so as to know if his points credit is sufficient to cover the price of the article. If this is the case, the visitor can access the article body page PCA.

In the case where the point credit of the visitor is insufficient, the latter is invited to reload his points credit (block RC). If this is not the case, the visitor is sent to the summary page PA.

In the case where the visitor accepts and reloads his points credit, he shall complete a form concerning registration, subscription, payment and points account reload (block FIS). He shall then be invited to become a member of the site SD. The visitor shall then be determined on the choice of a currency (block CDE) and shall make a payment on line (block PL) after validity control K₂ of the currency and the selected amount.

Once control of validity of the payment is made (block K₃), the account of the visitor is credited (block CCR) and the latter is taken back to the summary page PA where he could again select another article.

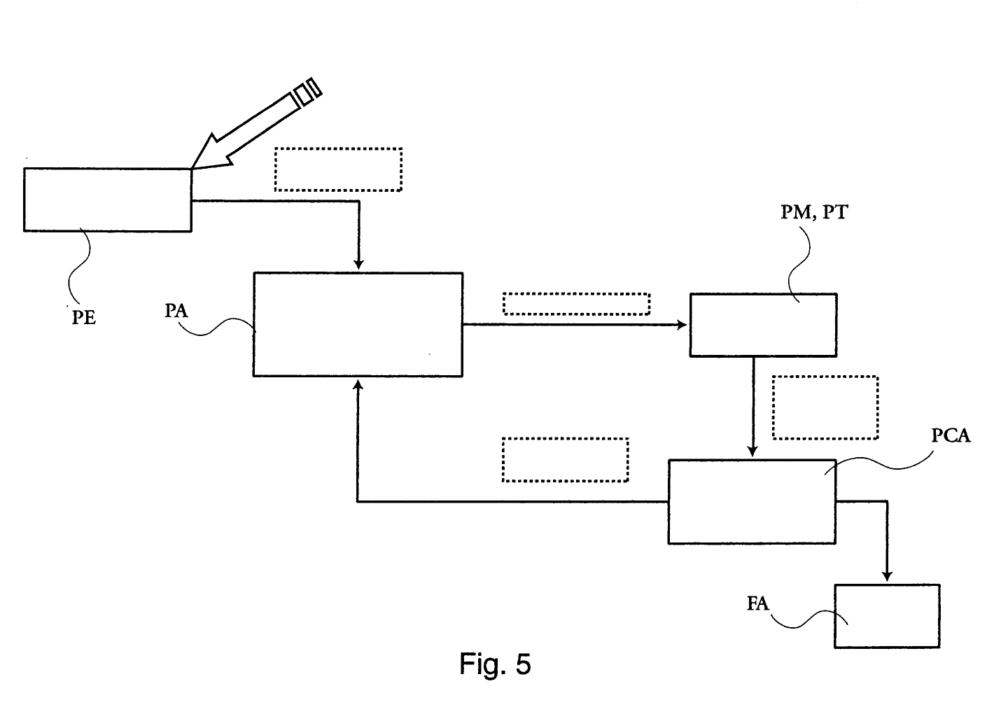

In the case where he wishes to look at a free access article, the visitor could access the summary page PA after having clicked a heading “unregistered visitor” on the entry page PE of the site SD. The visitor could then validate a heading called “zero point article” so as to reach the mosaic and tunnel pages PM, PT. The visitor shall again validate the article initially asked for so as to obtain a page including the requested article body PCA, as well as a general menu. The visitor could have access to an evaluation form FA concerning the article. Once this page has been consulted, the visitor could return to the summary page PA (FIG. 5).

1. Method for promoting, organising and managing on a network communications and exchanges between at least two populations, namely: a population of canvassing entities, each seeking to enter in communication with target entities satisfying pre-established criteria, and a target population including the target entities of the canvassing entities, this method introducing a server centre connected to the network and which carries out on behalf of each of the canvassing entities the following operations:
the selection of the target entities according to criteria determined by the canvassing entity and/or the server centre so as to set up an overall file for this canvasser,
the supplying to the entities the target file with means for accessing a general information presentation site whose contents are independent of the activity of the canvasser and having an attractive nature, this general information presentation site being exclusively reserved for the entities featured in the target files of all the canvassing entities taken in charge by the server centre, and
the presentation to each of the target entities seeking to access the general information presentation site information specific to the canvasser for which it has been selected.

2. Method according to claim 1 and including the presentation by the server to any entity which so desires of all the canvassing entities, as well as the synthetic presentation of the general information of the general information presentation site.

3. Method according to claim 1 in which access by the target entities to the general information presentation site requires an access code which is offered to the target entities by the canvassing entities.

4. Method according to claim 3 in which access to the general information presentation site is effected via a tunnel page selected according to the access code which contains general information concerning at least the canvassing entity which has provided it with the access code, as well as means for controlling access to the general information presentation site.

5. Method according to claim 4 in which the tunnel page is associated with a mosaic page.

6. Method according to claim 4 in which the tunnel page and/or the mosaic page enable the target entity to access an offer, possibly personalised, of the canvassing entity which has provided it with the access code.

7. Method according to claim 4 in which said tunnel page includes means for accessing the Internet site of the canvassing entity.

8. Method according to claim 4 in which said tunnel page includes a call button making it possible to enter into audio and/or video communication with the canvassing entity which has provided it with the access code.

9. Method according to claim 1 in which the services sale commercial site sets up for each canvassing entity a park of target entities to which it allocates a key able to be used by one or several visitors as part of an operation.

10. Method according to claim 1 in which the general information presentation site includes free information and information subject to payment via a points account.

11. Method according to claim 9 in which said key enables a visitor to benefit from a points account credit able to be used to access the paying information.

12. Method according to claim 9 in which said key is used to create a parameterable number of login/password pairings used for controlling access to the general information presentation site.

13. Method according to claim 9 in which the keys have a period of validity during which a destination entity is able to access the general information presentation site.

14. Method according to claim 12 in which the logins belong to the following four types:
an administration login for accessing the global indicators of the site and all the articles of the general information presentation site,
a visitor login provided for visitors not having subscribed to the general information presentation site,
a subscription login consisting of a visitor login where said visitor has subscribed to the general information presentation site,
an offered login consisting of a login derived from a key, this login being valid as long as the operation corresponding to the key is still taking place and for a predetermine period after the end of this operation.

15. Method according to claim 4 in which the registration of a visitor on the general information presentation site is effected according to a mode, with or without a key, in which the visitor is identified in a form and is able to participate in a game decided by a random draw.

16. Method according to claim 15 in which the registration of a visitor provided with a valid key gives right to a pre-parametered points credit.

17. Method according to claim 15 in which the registration of a visitor not having any key includes the payment of a subscription fee.
